(19) United States
(12) Patent Application Publication
(10) Pub. No.: US 2012/0099913 A1
(43) Pub. Date: Apr. 26, 2012

(54) SYSTEM AND METHOD OF GAUGING PAPER WORKFLOW

(75) Inventor: Jimmy Joseph, Bangalore (IN)

(73) Assignee: GENERAL ELECTRIC COMPANY, Schenectady, NY (US)

(21) Appl. No.: 12/915,507

(22) Filed: Oct. 29, 2010

(30) Foreign Application Priority Data
Oct. 21, 2010 (IN) 3109/CHE/2010

(51) Int. Cl. B41J 11/42

(52) U.S. Cl. 400/582

(57) ABSTRACT

Systems and methods of monitoring a paper supply include a paper receptacle retains a supply of paper. The supply of paper includes at least one queue mark. A sensor detects the at least one queue mark. A processor receives a signal indicative of the at least one queue mark and calculates a value representative of a remaining amount of paper in the paper supply.

### CROSS-REFERENCE TO RELATED APPLICATION

The present application is based on and claims priority to Indian Patent Application Serial No. 3109/CHE/2010 filed on Oct. 21, 2010.

### BACKGROUND

The present disclosure relates to the field of printing acquired data. More specifically, the present disclosure relates to monitoring a paper reserve of a printer.

Recorded sensor signals are known to be stored in a variety of ways. These include both electronic storage as well as “hard copy” storage. Typically, a “hard copy” involves the printing of the recorded signal data on a sheet of paper or the development of film with recorded signal data. These physical records can then be stored for later retrieval and use that is independent of computer operation or access.

One particular non-limiting application that is described in greater detail herein, is the acquisition and storage of biopotential signals from a patient. Various physiological functions are characterized by electrical impulses that can be acquired from electrodes secured to the body of the patient, typically adhere to the skin.

Often, it can be desirable for a physical copy of the recorded biopotential signals to be printed for reference, analysis, or recordation.

### BRIEF DISCLOSURE

The present disclosure relates to a system for monitoring a paper supply. The system includes a paper receptacle configured to retain the paper supply. The paper supply includes at least one queue mark. The printer receives paper from the paper supply and affixes a graphical representation to the paper. A sensor is responsive to the at least one queue mark. The sensor produces a signal indicative of sensing the queue mark. A controller receives the signal from the sensor and calculates a value representative of a remaining amount of paper in the paper supply.

A method of monitoring a paper supply includes receiving a supply of paper into a paper receptacle of an automatic sheet feeding printer. A queue mark is provided on each sheet of paper of the supply of paper. A processor receives an indication of a number of sheets in the supply of paper. The queue mark of each sheet of paper is detected as each sheet of paper passes through the automatic sheet feeding printer. An indication of a remaining number of sheets of paper is provided.

A biopotential monitoring system disclosed herein includes a controller configured to receive a biopotential signal acquired from the patient. A graphical display is operated by the controller to visually present the received biopotential signal. A printer is operated by the controller to affix a graphical representation of the biopotential signal to the at least one sheet of paper. The at least one sheet of paper includes a queue mark. A paper receptacle holds at least one sheet of paper prior to use by the printer. A sensor is affixed in proximity to the printer. The sensor senses the queue mark on the at least one sheet. The sensor provides a signal indicative of a sensed queue mark to the controller. The controller calculates a value representative of a remaining number of sheets of paper in the paper receptacle. The controller operates the graphical display to present the calculated value.

### BRIEF DESCRIPTION OF THE DRAWINGS

FIG. 1 is an exemplary embodiment of a system for monitoring a paper supply.

FIG. 2 is a schematic diagram of an embodiment of a system for monitoring a paper supply.

FIG. 3 is a close up view of the embodiment depicted in FIG. 1 designated by the reference numerals 3-3.

FIG. 4 is a flow chart depicting an embodiment of a method of monitoring a paper supply.

FIG. 5 is a flow chart depicting an alternative embodiment of a method of monitoring a paper supply.

### DETAILED DISCLOSURE

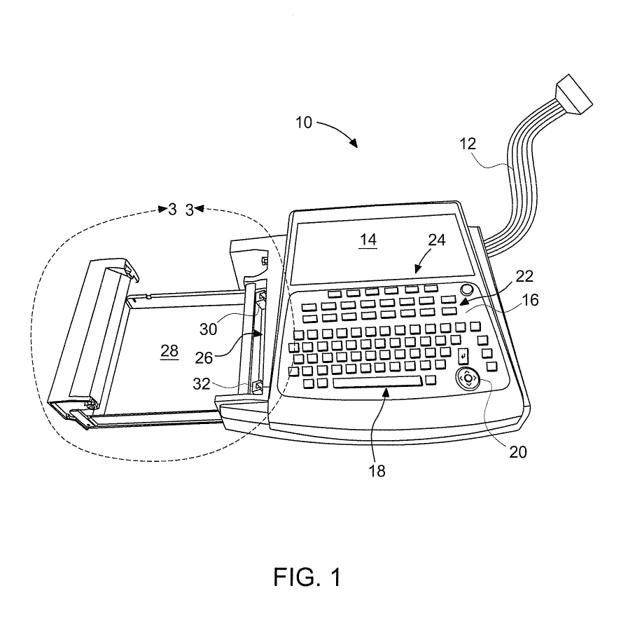

FIG. 1 is a portable signal acquisition system, exemplarily described herein as a electrocardiograph (ECG) monitor 10. It is understood that the ECG monitor 10 is merely an example of a signal acquisition system, and other biopotentials may be acquired such as in electromyography and electroencephalography. Alternative embodiments are not restricted to the medical field and similarly are not restricted to biopotential signals, as would be recognized by one of ordinary skill in the art.

A purely exemplarily embodiment of the ECG monitor 10 may be the commercial product sold under the name MAC1600, available from Assignee General Electric Company.

The ECG monitor 10 includes a plurality of leads 12 that extend to a patient (not depicted). Leads 12 are shown as a single combined cable; however, it is understood that the leads 12 may separate to individual wires or sensors that are affixed to a patient to acquire various biopotential signals.

The ECG monitor 10 receives the biopotential signals and performs signal processing on the received biopotential signals in order to identify leads of biopotentials. A lead is defined as the difference between biopotentials recorded at two or more locations on a patient. In an ECG, the leads reflect the propagation of electrical signals through the patient's heart along various planes defined by the leads.

The ECG monitor 10 includes a graphical display 14 that visually presents the acquired leads. The graphical display 14 is further used to present prompts to solicit the entry of data by a user. The user can enter data through a user interface 16. The user interface 16 may be an integral part of the ECG monitor 10, or may be an auxiliary component that is communicatively connected to the ECG monitor 10. An embodiment of the user interface 16 includes a keyboard 18 which may be a standard QWERTY style keyboard. The user interface 16 may further include a directional pad 20 that is used to navigate a cursor within the graphical display 14. Also, embodiments of the user interface 16 include a variety of preprogrammed function buttons 22, or alternatively, soft keys 24. It will be recognized by one of ordinary skill that these examples of user interfaces are merely exemplary, and a variety of other known user interfaces may be used within embodiments within the scope of this disclosure.

The ECG monitor 10 further includes a printer 26 that is controlled as is disclosed further herein in order to create a physical or hard copy of the visual presentation of the leads from the graphical display 14. The printer 26 may be any of the known printer types including, but not limited to, inkjet and laser printers.

The printer 26 prints the graphical representation of the leads on paper stock that is loaded into the ECG monitor 10 in the paper tray 28.

In operation, the paper from the paper tray 28 is fed into the printer 26 which prints a graphical representation of the leads on the paper. As the leads are printed on the paper, the paper is fed out of the printer 26 and the ECG monitor 10 for review and collection by a clinician.

The paper in the paper tray 28 may be of a variety of styles including continuous z-fold paper stock with perforated pages, or individual leaf pages. One common feature of the paper placed in paper tray 28 is that each page includes a queue mark, which will be described in further detail herein. In embodiments, the queue mark is printed on each page of the paper. The queue mark printed on each page is printed in a detectable substance either being opaque, reflective, ferromagnetic, or others as will be recognized by one of ordinary skill. In an alternative embodiment, the queue mark is a physical property of a portion of the page. This may include, but is not limited to a cutout or perforation. The at least one queue mark indicates the start of a new page of paper.

Typically, a printed hard copy of the ECG leads extends over a plurality of pages of paper. The start of the printout includes identifying information regarding the obtained biopotentials, including start time, lead identifications, patient information, monitoring device identification, or the like. In order to ensure that this information fits on the first page of the hard copy, a queue mark sensor 30 detects the queue mark on a page in order to operate the printer 26 to begin the printout on a start of a new page of paper. While some embodiments of the ECG monitor 10 use a single queue mark sensor 30, alternative embodiments include a second queue mark sensor 32, or more (not depicted).

The queue mark sensor 30 can be implemented in a variety of sensors sensing schemes. One embodiment of the queue mark sensor 30 uses light such as visible, infrared (IR), or ultraviolet (UV) light and senses the reflection or absorption of the projected light by the paper. The queue mark alters this characteristic of the paper by reflecting more or less of the projected light than the untreated paper. Alternatively the queue mark sensor 30 may be an electromagnetic sensor and the queue mark is a ferromagnetic substance. The presence of the ferromagnetic substance of the queue mark thus changes the magnetic field sensed by the electromagnetic sensor.

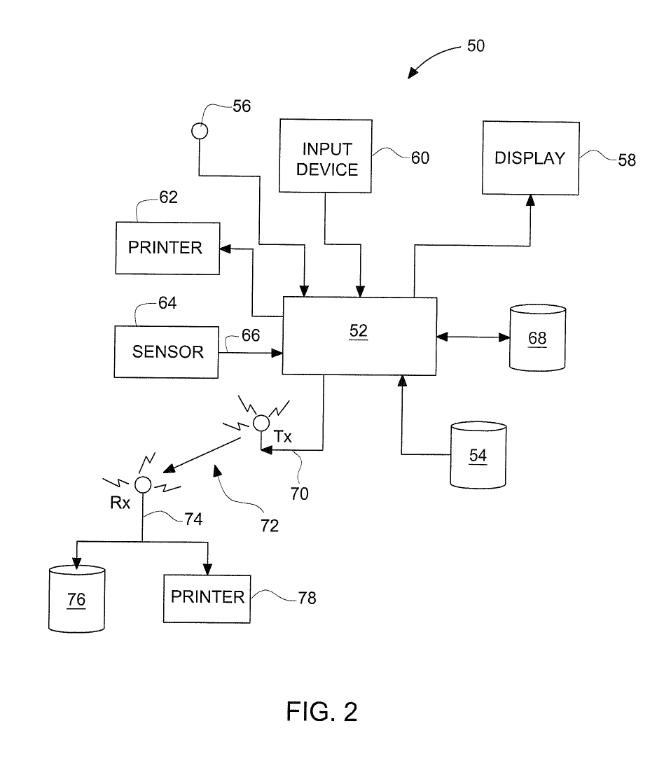

FIG. 2 is a schematic diagram that depicts an embodiment of the electrical and communicative components of an embodiment of a system for monitoring a paper supply 50. In an embodiment, the system 50 is within the ECG monitor 10 depicted in FIG. 1.

The system 50 includes a controller 52. The controller 52 may be a microcontroller or a microprocessor that executes computer readable code that is stored on a computer readable medium 54 that may be integrated with the controller 52 or may be a separate component to the controller 52, but is communicatively connected to the controller 52. The computer readable medium 54 is any of a known variety of non-transient computer readable mediums. In embodiments, the computer readable medium is a non-volatile computer memory (e.g. EEPROM or FLASH memory); however, this is not limiting on the scope of computer readable mediums that may be used.

The controller 52 executes the computer readable code stored on the computer readable medium 54 in order to operate to carry out the functions and indications as disclosed herein. The controller 52 receives electrical sensor signals from at least one transducer 56. As has been described above, in the exemplary disclosure, the transducer is a biopotential transducer; however, this is not intended to be limiting on the scope of the transducers that may be used in embodiments of the system. The controller 52 executes computer readable code from the computer readable medium 54 to process the biopotential signals from the transducer 56 in order to arrive at the desired acquired signals. These signals are visually presented on the graphical display 58. The graphical display 58 presents a graphical user interface (GUI) as operated by the controller 52. The visual representation of the acquired signals are presented within the GUI. Additionally, the controller 52 may operate the display 58 to present one or more GUIs that include messages or other prompts to a clinician for the entry of additional information by the clinician. This entry of additional information is facilitated through the input device 60. Non-limiting examples of the types of input devices 60 that may be used in embodiments of the system 50 are described above with respect to FIG. 1.

The controller 52 further operates a printer 62 to affix a graphical representation of the signals on one or more pieces of paper. In embodiments, the graphical representations of the signals affixed by the printer 62 to the paper are substantially the same as the signals visually presented by the display 58. In an embodiment, the printer 62 and the display 58 simultaneously provide the visual representation of the signals. In an alternative embodiment, the printer 62 operates on a delay to present the graphical representation of signal on the paper after the presentation of the same signals on the graphical display 58.

At least one sensor 64 is positioned in relation to the printer 62 and a paper receptacle (not depicted). The sensor 64 is arranged to sense a queue mark on each page of paper from the paper receptacle as the page of paper is fed through the printer 62 to receive the visual representation of the signal. In an embodiment, the pages of paper are in a continuous perforated roll or z-fold stack, while in other embodiments, the paper may be individual sheets. When the sensor 64 senses a queue mark, the sensor 64 produces a queue mark signal 66 that is sent back to the controller 52 to indicate to the controller 52 each page of paper that is fed through the printer 62.

Additionally, the controller 52 may be connected to memory 68 or other individual storage. In an embodiment, the memory 68 is an integral part disposed within the ECG monitor 10 (FIG. 1). Alternatively, the memory 68 may be an external memory that is communicatively connected to the ECG monitor 10 (FIG. 1). In this embodiment, the memory 68 may be, but is not limited to a flash drive or a writable CD ROM. The controller 52 may further be connected to a transmitter 70. The transmitter 70 forms one part of a communication connection 72. In embodiment, the communication connection 72 is a wireless communication connection between a transmitter 70 and a receiver 74. Other examples of communication connection 72 that may be used within the scope of the present disclosure are a wired connection or an optical connection, such as through fiber optics or infrared communication. The communication connection 72 communicatively connects the controller 52 to a location remote from the controller 52. At the remote location, a remote memory 76 and/or a remote printer 78 are located. In one embodiment, the remote memory 76 and the remote printer 78 may be a centrally located computer memory storage and printer capabilities, such as in a hospital information technology infrastructure. The remote memory 76 and the remote printer 78 are used in a variety of ways within the scope of the present disclosure, as will be described in further detail herein.

In operation, the controller 52 receives queue mark signals 66 from the sensor 64. When the system 50 begins to monitor a biopotential with the transducer 56, the controller 52 operates the printer 62 to advance the paper through the printer 62. The sensor 64 monitors the paper for a queue mark and upon the detection of a queue mark, produces a queue mark signal 66 which is sent to the controller 52. The controller 52 then operates the printer 62 to begin printing a graphical representation of the acquired biopotential on the paper, which has now been aligned on the page by sensing the queue mark. The controller 52 may further operate the display 58 and the memory 68 to both display and locally store the acquired biopotential signal.

In a further operation of the system 50, when a clinician loads the paper into the printer 62, the controller 52 operates the display 58 to visually present a prompt for the clinician to use the input device 60 in order the enter the number of pages that have been loaded into the printer. This may be done in a variety of ways. In one embodiment, the paper is loaded in standardized packages of paper and therefore identification or confirmation of the standardized package is entered with the input device 60. Alternatively, a known number of pages is manually entered into the input device 60. In this manner, the controller 52 is loaded with the initial paper count. In an embodiment, the controller 52 operates the display 58 to present a visual indication of the number of pages remaining in the paper supply of the printer 62. Each time the sensor 64 senses a queue mark on a page of paper in the printer 62, the sensor 64 produces a queue mark signal 66 that is sent to the controller 52. Upon receiving a queue mark signal 66, the controller 52 subtracts one page from the stored remaining page count and modifies the visual presentation on the display 58.

As the pages remaining in the printer 62 are used up and the presented remaining pages approaches zero, the controller 52 may operate in a variety of manners to ensure that the acquired biopotential signal data is not lost if the paper supply runs out. These actions by the controller 52 may be initiated when the paper remaining count falls below a predetermined threshold. In some embodiments, a variety of thresholds may be monitored by the controller 52. These thresholds may indicate various levels of warning or concern regarding the remaining paper level. Therefore, the controller 52 operates in a manner to adequately backup the acquired biopotential signals based upon the monitored risk.

In one embodiment, the controller operates the memory 68 to locally store the acquired biopotential signals, if the signals are not already being locally archived. Alternatively, the controller 52 uses the communication connections 72 to send the acquired biopotential signals to the store at the remote memory 76. In both of these embodiments, the controller operates local or external memory in order to preserve the acquired data. Therefore, if the printer 62 runs out of paper, then the acquired biopotential signals have been visually stored and a paper record can be printed at another time.

Alternatively, upon detecting a low paper condition, the computer 52 can operate the communication connection 72 in order to send the acquired biopotential signals to the remote printer 78. In this embodiment, a hard copy paper printout of the biopotential signals is maintained, despite the potential risk for the printer 62 running out of paper.

In addition to the operation of the memory 68, 76 or the printer 78, the controller 52 operates the display 58 in order to present an additional visual or audible warning or alert that is indicative of the low paper condition.

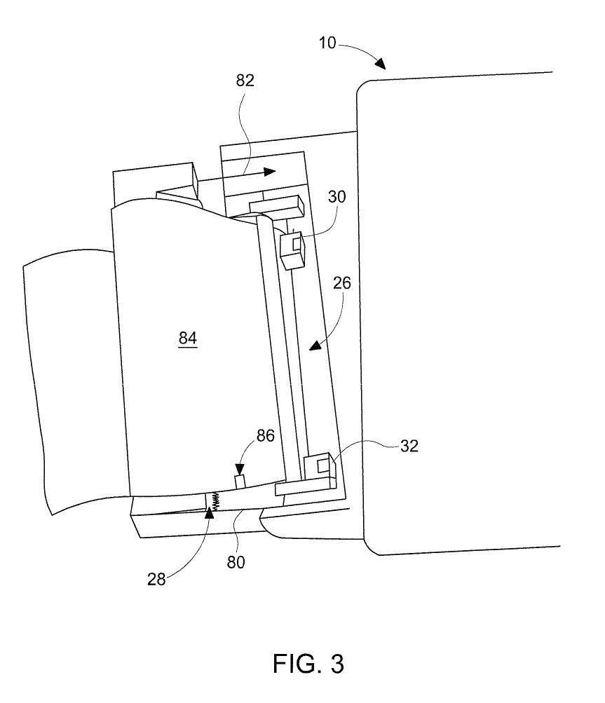

FIG. 3 is a close up view of a portion of the ECG monitor 10 of FIG. 1. Like reference numerals from FIG. 1 have been used in FIG. 3 in order to denote like structures and features.

FIG. 3 depicts the ECG monitor 10 with a paper tray 28 that is loaded with a supply of paper 80. The paper tray 28 is partially closed in the direction of arrow 82. It is understood that during operation of the ECG monitor 10, the paper tray 28 is in a fully closed position by slidably moving the paper tray 28 in the direction of arrow 82. A sheet of paper 84 is depicted that extends out of the ECG monitor 10 past the printer 26. At least one queue mark 86 on the sheet of paper 84 is detected by one of the queue mark sensors 30, 32.

In embodiments, the page of paper 84 includes more than one queue mark 86. In embodiment, the queue marks 86 are found in different locations on the page of the paper 84 and therefore multiple queue mark sensors 30, 32 may be used. The queue mark sensors 30, 32 sense the queue marks 86 as the paper page 84 is fed through the printer 26.

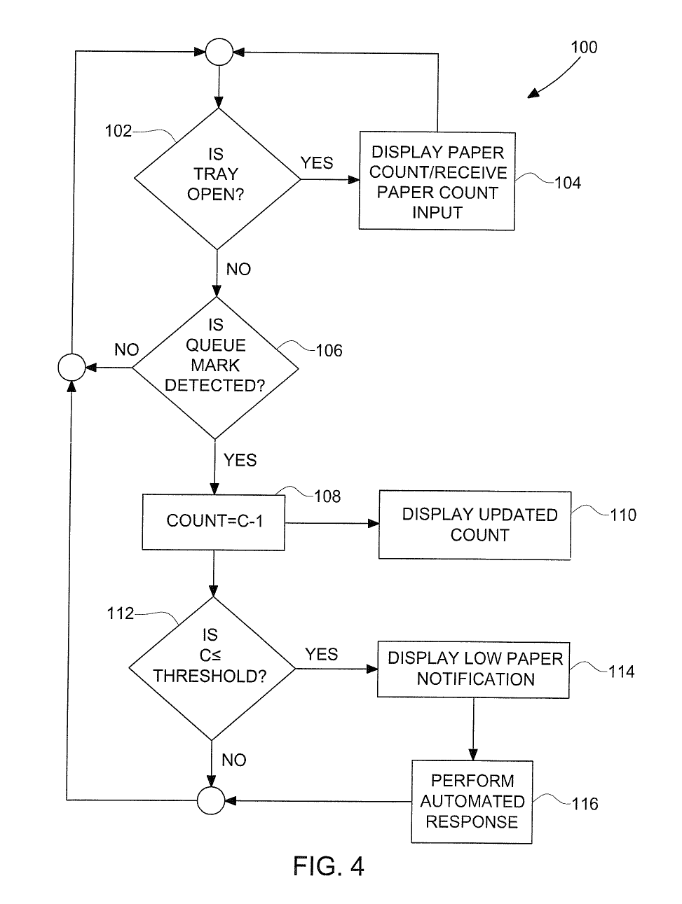

FIG. 4 is a flow chart that depicts an embodiment of a method of monitoring a paper supply. The method 100 may be performed by the controller 52 to operate computer readable code stored on the computer readable medium 54.

First, the controller identifies at 102 if the paper tray is open. If the paper tray is open, then the controller operates the display to either present a standard full paper tray count to be confirmed by a user of clinician after the paper has been loaded into the tray. Alternatively, (upon loading the paper tray) the controller receives an input of the paper count placed in the tray at 104 by the clinician.

If the tray is not open, then at 106 the controller determines if a queue mark has been detected. A queue mark appears on each of the pages of the paper placed in the paper tray. A queue mark sensor as described above senses the queue marks and produces a signal that is indicative of a sensed queue mark. If a queue mark is not detected, then the method 100 returns to the start of the method. If a queue mark is detected, then according to the method 100, the count of the remaining paper is incremented to reduce the remaining pages count by one page at 108.

Optionally, at 110, the controller operates a graphical display to display the updated count. This provides a continuous presentation of the remaining number of pages.

Next, at 112, the incremented count from 108 is compared to a predetermined threshold that is indicative of a remaining paper status. In one embodiment, there is a single threshold that is representative of a low paper condition. In an alternative embodiment, there are a plurality of thresholds to which the remaining paper count is compared. These thresholds may indicate varying levels of severity of the detected low paper condition. If varying severities of the detected low paper condition are identified, then an automated response taken, as described in further detail herein, may be varied in accordance with the determined severity.

If the remaining paper count is below the predetermined threshold, then at 114 the controller operates the display to present a low paper notification. This notification may be in the form of a textual indication or the illumination of a light or other indicator. Alternatively, the notification of low paper may be an alarm or other audible tone that conveys the notification to a clinician. Additionally, at 116, the controller performs an automated response to the detected low paper condition. The automated response may be displaying the low paper notification; however, in alternative embodiments, the automated response at 116 is the storage or transmission of the biopotential data to a storage device or a backup printer to ensure that the acquired biopotential signals are not lost in the event that the ECG machine 110 runs out of paper.

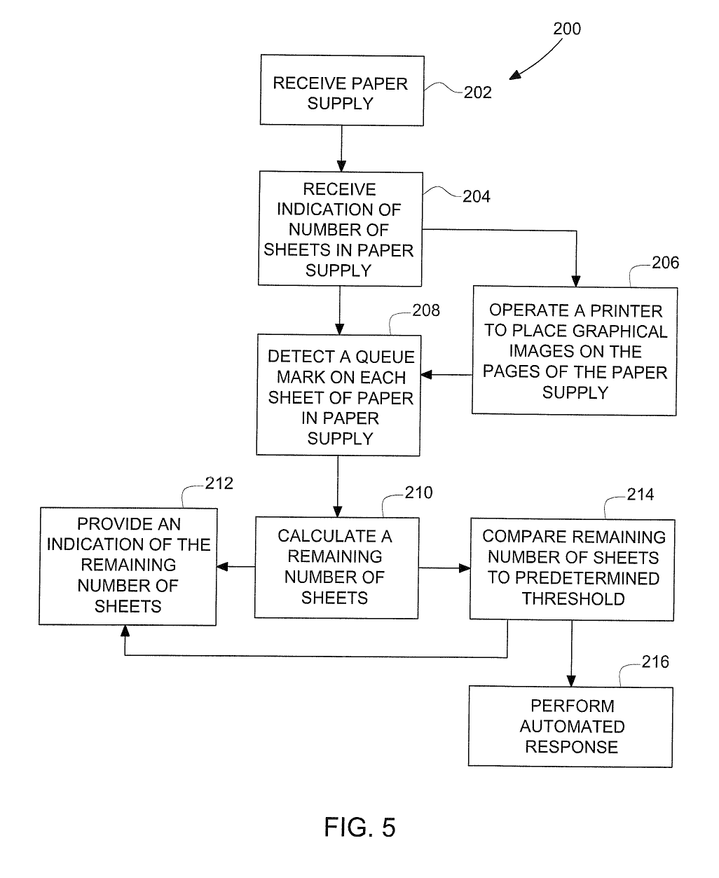

FIG. 5 depicts an embodiment of a method 200 of monitoring a paper supply. The method 200 may be performed using a device as disclosed above. Such a device includes a processor that performs one or more of the previous functions identified herein.

At 202, a supply of paper is received into a paper receptacle, which in an embodiment, is a paper receptacle of an automatic sheet feeding printer.

At 204, a controller receives an indication of a number of sheets of the paper supply received into the paper receptacle at 202. This indication can be in the form of a user input. Alternatively, the indication may be stored based upon a standard size or operation of the device and the paper receptacle of the device. In a still further embodiment, the indication of the number of sheets of paper may come from an identification of a serial or other identification number of the package of paper placed in the paper receptacle where the identification or serial number identifies the count of the paper supply.

At 206, a printer is operated to place graphical images on a page of the paper supply. As each page of the paper supply is fed through the printer, at 108 a queue mark on each sheet of paper is detected. As disclosed above, the queue mark can be detected by a sensor that is selected to be able to detect the queue marks whether the sensor detects a property of the mark itself, voids in the paper, paper texture, or another marking scheme.

At 210, for each detected queue mark, a remaining number of sheets of paper in the paper supply is calculated. The calculated remaining number of sheets from 210 is used in 212 to provide an indication of the remaining number of sheets. This indication of the remaining number of sheets may be a visual presentation of an actual number of remaining number of sheets. In an alternative embodiment, the indication of the remaining number of sheets may be visual presentation of a range of remaining number of sheets. One such example of a presentation of a remaining number of sheets range includes the illumination of varying colors of lights, such as light emitting diodes (LEDs) such as to indicate that the paper supply is full (green), low (yellow), or empty (red).

At 214, the remaining number of sheets of paper calculated at 210 is compared to a predetermined threshold. The predetermined threshold may be indicative of various severities of the paper level. Such as was described above with respect to 212, a plurality of predetermined thresholds may exist in order to define varying categories of the remaining number of sheets.

At 216, an automated response is performed based upon the remaining number of sheets and the one or more predetermined thresholds met by the calculated remaining number of sheets. Thus, a response such as a visual indication, an audible indication, a textual or other electronic communication message, the backup, transmission, or transfer of acquired data may be performed based upon a determined severity of the determined remaining number of sheets.

The presently disclosed systems and methods perform automated monitoring and responses to detected low paper conditions within a signal acquisition unit. Current systems require a user to be present in order to visually inspect the paper hard copy record used by the printer to evaluate the remaining paper supply to the printer. By the presently disclosed automated detection and response to low paper conditions, these situations may be monitored and handled with limited user attention and intervention.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Various alternatives and embodiments are contemplated as being with in the scope of the following claims, particularly pointing out and distinctly claiming the subject matter regarded as the invention.

What is claimed is:

1. A system for monitoring a paper supply, the system comprising:
a paper receptacle configured to retain the paper supply, the paper supply comprising at least one queue mark;
a printer that receives paper from the paper supply and affixes a graphical representation to the paper;
a sensor responsive to the at least one queue mark, that produces a signal indicative of sensing a queue mark; and
a controller that receives the signal from the sensor and calculates a value representative of a remaining amount of paper in the paper supply.

2. The system of claim 1, further comprising a graphical display that is operated by the controller to present the remaining amount of paper in the paper supply.

3. The system of claim 2, further comprising an input device that prompts entry of an amount of paper placed in the paper receptacle and receives an input representative of the amount of paper placed in the paper receptacle.

4. The system of claim 3, wherein the paper supply comprises a plurality of pages of paper and each page of paper comprises at least one queue mark, the sensor sends a signal representative of each sensed queue mark to the controller, and the controller subtracts one page from the presented remaining amount of paper for each sensed queue mark.

5. The system of claim 4, wherein the controller further uses the signal indicative of sensing a queue mark from the sensor to operate the printer such that the graphical representation affixed to the paper is aligned with the paper.

6. The system of claim 4, wherein the controller receives a biopotential signal and operates the printer to affix a graphical representation of the biopotential signal to the paper.

7. The system of claim 6, further comprising a computer readable medium communicatively connected to the controller, wherein the controller operates the computer readable medium to store the receive biopotential signal based upon the calculated value representative of the remaining amount of paper in the paper supply.

8. The system of claim 7, wherein the computer readable medium is a non-volatile computer memory.

9. The system of claim 7, wherein the controller compares the calculated value to a predetermined value indicative of a low paper supply.

10. The system of claim 6, further comprising a wireless transmitter connected to the controller, wherein the controller operates the wireless transmitter to send the received biopotential signal to a remotely located electronic device based upon the calculated value representative of the remaining amount of paper in the paper supply.

11. A method of monitoring a paper supply, the method comprising:
receiving a supply of paper into a paper receptacle of an automatic sheet feeding printer;
providing a queue mark on each sheet of paper of the supply of paper;
receiving, with a processor, an indication of a number of sheets in the supply of paper;
detecting the queue mark of each sheet of paper as each sheet of paper passes through the automatic sheet feeding printer; and
providing an indication of a remaining number of sheets of paper in the supply of paper.

12. The method of claim 11, further comprising detecting when the remaining number of sheets of paper in the supply of paper falls below a predetermined number.

13. The method of claim 12, further comprising:
receiving a biopotential signal with the processor; and
operating the automatic sheet feeding printer with the processor to print the biopotential signal on the supply of paper.

14. The method of claim 13, wherein upon detecting that the remaining number of sheets of paper falls below the predetermined number, storing the biopotential signal in a computer readable memory.

15. The method of claim 14, further comprising:
transmitting the biopotential signal from the processor to a remote storage device; and
printing the biopotential signal from a printer communicatively connected to the remote storage device.

16. A biopotential monitoring system, the system comprising:
a controller configured to receive a biopotential signal acquired from a patient;
a graphical display operated by the controller to visually present the received biopotential signal;
a printer operated by the controller to affix a graphical representation of the biopotential signal to at least one sheet of paper, the at least one sheet of paper being marked with a queue mark;
a paper receptacle in which the at least one sheet of paper is held prior to use by the printer;
a sensor affixed in proximity to the printer, the sensor senses the queue mark on the at least one sheet;
wherein the sensor provides a signal indicative of a sensed queue mark to the controller, the controller calculates a value representative of a remaining number of sheets of paper in the paper receptacle, and the controller operates the graphical display to present the calculated value.

17. The biopotential monitoring system of claim 16, further comprising:
a user input device operated by the controller;
wherein upon determining that the paper receptacle is open, the controller operates the graphical display to prompt a user to enter a number of sheets of paper placed in the paper receptacle and receives an input value from the user input device.

18. The biopotential monitoring system of claim 16, further comprising:
a computer readable medium communicatively connected to the controller;
wherein the controller operates the computer readable medium to store the received biopotential signal based upon the calculated value representative of the remaining number of sheets of paper in the paper receptacle.

19. The biopotential monitoring system of claim 18, further comprising:
a wireless transmitter communicatively connected to the controller;
wherein the controller operates the wireless transmitter to send the received biopotential signal to a remotely located electronic device based upon the calculated value representative of the remaining number of sheets of paper in the paper receptacle.

20. The biopotential monitoring system of claim 19, wherein the controller compares the calculated value to at least one predetermined value indicative of a low paper supply before operating the computer readable medium or the wireless transmitter.
